(19) United States
(12) Patent Application Publication
(10) Pub. No.: US 2023/0252538 A1
(43) Pub. Date: Aug. 10, 2023

(54) SYSTEMS AND METHODS FOR UPDATING ELECTRONIC LABELS BASED ON PRODUCT POSITION

(71) Applicant: Omni Consumer Products, LLC, Addison, TX (US)

(72) Inventor: Stephen Howard, Dallas, TX (US)

(73) Assignee: Omni Consumer Products, LLC, Addison, TX (US)

(21) Appl. No.: 18/004,516

(22) PCT Filed: Jul. 6, 2021
(86) PCT No.: PCT/US2021/040548

§ 371 Date: Jan. 6, 2023

Related U.S. Application Data
(60) Provisional application No. 63/049,107, filed on Jul. 7, 2020.

(51) Int. Cl. G06Q 30/0601; G06Q 10/087

(52) U.S. Cl. CPC G06Q 30/0601; G06Q 10/087

(57) ABSTRACT

A price monitoring system includes a memory and a processor configured to: determine, by the price monitoring system, an identity of a determined product positioned a particular location based on image information regarding the determined product, compare, by the price monitoring system, the identity of the determined product positioned at the particular location to an identity of an assigned product assigned to that particular location, determine, based on the comparison, that the identity of the determined product positioned at the particular location does not match the identity of the assigned product assigned to that particular location, retrieve product information for the determined product positioned at the particular location from a product database, transmit instructions configured to command an electronic product label at the particular location to display the product information for the determined product positioned at the particular location.

### CROSS-REFERENCE TO RELATED APPLICATIONS

The disclosure claims priority to and benefit of U.S. Provisional Appl. No. 63/049,107, filed, Jul. 7, 2020, the entire disclosure of which is hereby incorporated by reference herein.

### FIELD OF THE INVENTION

The disclosure relates to systems and methods for updating electronic shelf labels so that the electronic shelf labels accurately describe a product positioned proximate the label.

### BACKGROUND

Many stores display products on shelves or other similar surfaces that include price labels positioned at or proximate the products for sale. The price labels typically include a name of the product and a price of the product. The price labels may be electronic labels that can be read and changed by a machine. Such price labels include machine-readable barcodes that encode information related to the product positioned above the label, such as the product name and the product price. In such stores, the products typically do not include pricing labels, so misplaced products have unknown prices or mismarked prices, which may lead to customer confusion. The price labels may be periodically changed to reflect changes in price and/or changes in a position of a product. Conventionally, the labels are changed by a human operator in a process that can be laborious and time-consuming. This operator walks the store with a scanner, scans the barcode on the electronic label, and visually confirms a match between the actual product displayed above the electronic label and the product identified on the label and/or a match between a price displayed on the label and an actual product price in a pricing database. In response to identifying a mismatch between the product positioned above the label and the identified on the label and/or a mismatch between the price on the label and the price in the pricing database, the scanner then updates the label.

### SUMMARY

Embodiments described herein generally relate to systems and methods for verifying the accuracy of electronic pricing labels and updating electronic pricing labels using a price monitoring system that includes a drone. Particularly, systems and methods described herein relate to a price monitoring system including a drone that is configured to assign identity information of a particular electronic label to a particular position on a planogram of a retail environment, associate a particular product with each of particular position in the planogram, and update the particular electronic label to show identity information and a price of the particular product. The drone is also configured to monitor the retail environment. In response to determining that a determined product identity in a particular position is different than an assigned product identity in the particular position, the drone is configured to update the electronic pricing label at the particular position to display identity information and the price of the determined product. The drone is further configured to update the database to replace the assigned product identity in the particular position with the determined product identity in the particular position.

In some embodiments, a price monitoring system includes a memory and a processor. The processor is configured to determine, by the price monitoring system, an identity of a determined product positioned a particular location based on image information regarding the determined product. The processor is configured to compare, by the price monitoring system, the identity of the determined product positioned at the particular location to an identity of an assigned product assigned to that particular location. The processor is configured to determine, based on the comparison, that the identity of the determined product positioned at the particular location does not match the identity of the assigned product assigned to that particular location. The processor is configured to retrieve product information for the determined product positioned at the particular location from a product database. The processor is configured to transmit instructions configured to command an electronic product label at the particular location to display the product information for the determined product positioned at the particular location.

In some embodiments, the processor is configured to replace the identity of the assigned product that particular location with the identity of the determined product positioned at the particular location within the product database.

In some embodiments, the processor is configured to transmit a message to a user device when the identity of the determined product positioned at the particular location does not match the identity of the assigned product assigned to that particular location indicating a misplaced item.

In some embodiments, the processor is configured to identify the electronic product label at the particular location based on a digital planogram of a retail space including the particular location.

In some embodiments, the price monitoring system includes an image capture device configured to capture an image of the determined product and the image information is determined from the captured image of the determined product.

In some embodiments, the image information is not determined based on a machine readable code displayed on the determined product.

In some embodiments, the electronic product label may be display product information including one or more of a product price, a product identification number, or a product description.

In some embodiments, a method includes determining, by a price monitoring system, an identity of a determined product positioned a particular location based on image information regarding the determined product, comparing, by the price monitoring system, the identity of the determined product positioned at the particular location to an identity of an assigned product assigned to that particular location, determining, based on the comparison, that the identity of the determined product positioned at the particular location does not match the identity of the assigned product assigned to that particular location, and transmitting instructions configured to command an electronic product label at the particular location to display the product information for the determined product positioned at the particular location.

In some embodiments, the method further includes replacing the identity of the assigned product assigned to that particular location with the identity of the determined product positioned at the particular location.

In some embodiments, the method further includes transmitting a message to user device when the identity of the determined product positioned at the particular location does not match the identity of the assigned product assigned to that particular location indicating a misplaced item.

In some embodiments, an apparatus includes a camera driving system and a price monitoring system. The price monitoring system includes a memory and a processor. The processor is configured to determine, by the price monitoring system, an identity of a determined product positioned a particular location based on image information regarding the determined product. The processor is configured to compare, by the price monitoring system, the identity of the determined product positioned at the particular location to an identity of an assigned product assigned to that particular location. The processor is configured to determine, based on the comparison, that the identity of the determined product positioned at the particular location does not match the identity of the assigned product assigned to that particular location. The processor is configured to retrieve product information for the determined product positioned at the particular location from a product database. The processor is configured to transmit instructions configured to command an electronic product label at the particular location to display the product information for the determined product positioned at the particular location.

In some embodiments, the camera driving system includes an image capture device coupled to a final drive system configured to capture an image of the determined product and the image information is determined from the captured image of the determined product.

In some embodiments, the processor of the camera monitoring system is configured to replace the identity of the assigned product assigned to that particular location with the identity of the determined product positioned at the particular location.

In some embodiments, the processor of the camera monitoring system is further configured to transmit a message to user device when the identity of the determined product positioned at the particular location does not match the identity of the assigned product assigned to that particular location indicating a misplaced item.

In some embodiments, the processor of the camera monitoring system is configured to identify the electronic product label at the particular location based on a digital planogram of a retail space including the particular location.

In some embodiments, the camera driving system includes an image capture device coupled to a final drive system configured to capture an image of the determined product; and the image information is determined from the captured image of the determined product.

In some embodiments, the image information is not determined based on a machine readable code displayed on the determined product.

In some embodiments, the electronic product label may display product information including one or more of a product price, a product identification number, and a product description.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is a schematic block diagram of a pricing display system including an electronic product label and a pricing monitoring system, according to an embodiment.

FIG. 2 is a block diagram illustrating an example of the pricing display system of FIG. 1 that includes the electronic label, a product, and the pricing monitoring system, according to an embodiment.

FIG. 3 is a schematic flow chart of a method for calibrating the pricing monitoring system of FIG. 1, according to an embodiment.

FIG. 4 is a schematic flow chart of a method for monitoring prices displayed in the price display system with the pricing monitoring system, according to an embodiment.

FIG. 5 is a schematic flow chart of a method for changing product information displayed by the electronic label in the price monitoring system of FIG. 1, according to an embodiment.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Embodiments described herein generally relate to systems and methods for verifying the accuracy of electronic pricing labels and updating electronic pricing labels using a price monitoring system that includes a drone. Particularly, systems and methods described herein relate to a price monitoring system including a drone that is configured to assign identity information of a particular electronic label to a particular position on a planogram of a retail environment, associate a particular product with each of particular position in the planogram, and update the particular electronic label to show identity information and a price of the particular product. The drone is also configured to monitor the retail environment. In response to determining that a determined product identity in a particular position is different than an assigned product identity in the particular position, the drone is configured to update the electronic pricing label at the particular position to display identity information and the price of the determined product. The drone is further configured to update the database to replace the assigned product identity in the particular position with the determined product identity in the particular position.

In the descriptions that follow, like parts are marked throughout the specification and drawings with the same numerals, respectively. The drawing figures are not necessarily drawn to scale and certain figures may be shown in exaggerated or generalized form in the interest of clarity and conciseness.

It will be appreciated by those skilled in the art that aspects of the present disclosure may be illustrated and described herein in any of a number of patentable classes or context including any new and useful process, machine, manufacture, or composition of matter, or any new and useful improvement thereof. Therefore, aspects of the present disclosure may be implemented entirely in hardware or combining software and hardware implementation that may all generally be referred to herein as a “circuit,” “module,” “component,” or “system” (including firmware, resident software, micro-code, etc.). Further, aspects of the present disclosure may take the form of a computer program product embodied in one or more computer readable media having computer readable program code embodied thereon.

Aspects of the present disclosure are described herein with reference to flowchart illustrations and/or block diagrams of methods, systems and computer program products according to embodiments of the disclosure. It will be understood that each block of the flowchart illustrations may be done in the same order of different order and that not all steps are required in every instance.

Conventionally, when electronic labels are deployed in a retail environment, a human selects a particular electronic label, identifies his/her current position in the retail space, and inputs identity information of the particular electronic label deployed at the current position into a position database by either manually typing the identity information or a barcode scanner to enter the identity information into the position database. This process is tedious and time consuming.

Conventionally, electronic labels in stores are manually updated to reflect an identity of a product positioned on a shelf above the electronic label. For example, a human operator may use a hand-held Bluetooth or a Near Field Communication (NFC) scanner to transmit a product identity and a product price to each electronic label in a retail environment. Periodically, a human operator may walk the retail environment to confirm that an identity of a product located at each particular position within the retail environment matches the identity of the product shown on the electronic label. The human operator may also verify that a price displayed on the electronic label matches a price for the product that is listed in a pricing database. For example, the human operator may scan a machine readable code on each electronic label to determine an identity and price of the product described by the electronic label. The human operator may then visually compare the product and/or the price of the product positioned at or proximate the electronic label to the identity and price of the product described by the electronic label.

In response to determining that the identity of the product at the particular position does not match the identity of the product shown on the electronic label and/or that the pricing information on the electronic label does not match the pricing information for the product listed in the pricing database, the human operator generally has to manually move the product back to its original position corresponding to the correct label associated with the product. This process is often laborious and time-consuming, often taking hours to complete. Furthermore, if products are moved (e.g., by a browsing customer), the pricing label at or proximate the product will not match the identity of the product until another human patrol.

In contrast, embodiments of the systems and methods described herein may provide one or more benefits including, for example: (1) assigning, in a position database, identity information of a particular electronic label to a particular product position on a planogram of a retail environment using a robot, (2) assigning, in a position database, information indicative of a product identity to each particular product position of the retail environment, (3) determining an identity of a current product positioned at a particular product position using image data of the product, and (4) transmitting instructions to the electronic label to display identity information and a price of the current product positioned at a particular product position in response to determining that the current product at the particular product position is different than the identity of the product assigned to the particular position in the position database. The systems and methods described herein use image data of the products currently positioned at each of the particular product positions rather than barcode scans of the electronic labels positioned at each particular product position, which allows use of low resolution cameras reducing cost and allowing easy integration with existing technology.

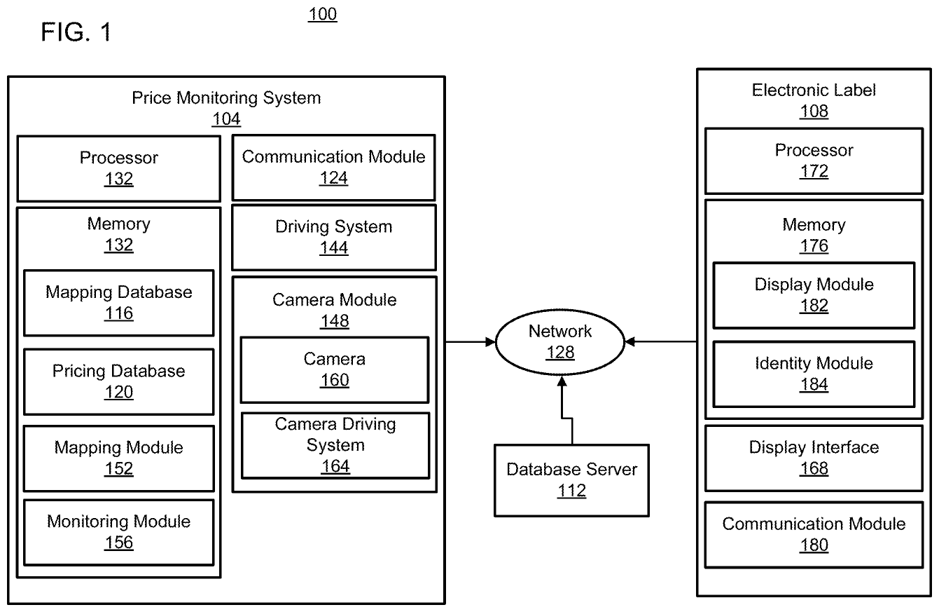

FIG. 1 is a block diagram illustrating an example pricing display system 100 that includes a price monitoring system 104 and a plurality of a plurality of electronic labels 108. In some embodiments, the pricing display system 100 includes a database server 112. In some embodiments, the database server 112 may include a mapping database 116 and a pricing database 120. In other embodiments, the mapping database 116 and the pricing database 120 may be stored locally on the price monitoring system 104. The price monitoring system 104, the plurality of electronic labels 108, and the database server 112 are in communication via a network 128.

The network 128 may include any suitable Local Area Network (LAN) or Wide Area Network (WAN). For example, the network 128 can be supported by Frequency Division Multiple Access (FDMA), Time Division Multiple Access (TDMA), Code Division Multiple Access (CDMA) (particularly, Evolution-Data Optimized (EVDO)), Universal Mobile Telecommunications Systems (UMTS) (particularly, Time Division Synchronous CDMA (TD-SCDMA or TDS) Wideband Code Division Multiple Access (WCDMA), Long Term Evolution (LTE), evolved Multimedia Broadcast Multicast Services (eMBMS), High-Speed Downlink Packet Access (HSDPA), and the like), Universal Terrestrial Radio Access (UTRA), Global System for Mobile Communications (GSM), Code Division Multiple Access 1× Radio Transmission Technology (1×), General Packet Radio Service (GPRS), Personal Communications Service (PCS), 802.11X, ZigBee, Bluetooth, Wi-Fi, any suitable wired network, combination thereof, and/or the like. The network 128 is structured to permit the exchange of data, values, instructions, messages, and the like between the price monitoring system 104, the plurality of electronic labels 108, and the database server 112. In other embodiments, the databases of the database server may be included in, or the database server 112 may be a part of, the price monitoring system 104.

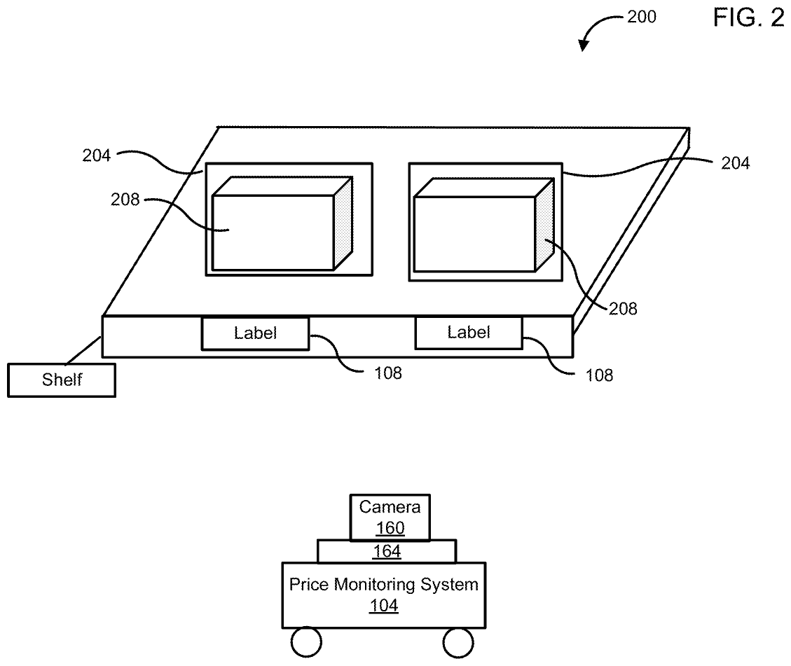

FIG. 2 illustrates a schematic representation of a retail environment 200. Each of the plurality of electronic labels 108 is positioned at a particular product position 204 of the retail environment 200. A product 208 may be positioned at the particular product position 204 such that the particular electronic label 108 at each product position 204 describes information regarding the product 208. In some embodiments, the mapping database 116 may include a planogram that indicates particular product positions 204 for the shelving space and/or floor space of the retail environment 200. The planogram includes identity information of the specific electronic label 108 positioned at each particular product positions 204 and identity information of the particular product 208 that is assigned to positioned at each particular product positions 204. In some embodiments, the planogram may include pricing information for the assigned product 208 at each predefined position. In other embodiments, the mapping database 116 may associate the particular product positions 204 with the particular electronic label 108 deployed at the particular product position 204 and the particular product 208 assigned to the particular product position 204 by another method (e.g., a look-up table, etc.).

Returning to FIG. 1, the price monitoring system 104 includes a processor 132, a memory 136, a communication module 140, a driving system 144, a camera module 148, a mapping module 152, a monitoring module 156, the mapping database 116, and the pricing database 120. The pricing database 120 includes a listing of all of the products 208 that may be sold in the retail environment 200 and pricing information for each of the products 208. The pricing database 120 may also include an assigned location for each product 208. The assigned product position 204 in the pricing database 120 typically matches the assigned product position 204 in the mapping database 116 unless the product position 204 in the mapping database 116 has been updated to reflect a misplaced product 208 (e.g., a product in a location different than the assigned location).

The processor 132 may be implemented as a general-purpose processor, an Application Specific Integrated Circuit (ASIC), one or more Field Programmable Gate Arrays (FPGAs), a Digital Signal Processor (DSP), a group of processing components, or other suitable electronic processing components.

The memory 136 stores data and/or computer code for facilitating at least some of the various processes described herein. The memory 136 includes tangible, non-transient volatile memory, or non-volatile memory. The memory 136 may include a non-transitory processor readable medium having stores programming logic that, when executed by the processor 132, controls the operations of the price monitoring system 104. The memory 136 may be any combination of one or more computer readable media. The computer readable media may be a computer readable signal medium, any type of memory or a computer readable non-transitory storage medium. For example, a computer readable storage medium may be, but not limited to, an electronic, magnetic, optical, electromagnetic, or semiconductor system, apparatus, or device, or any suitable combination of the foregoing. More specific examples of the computer readable storage medium may include, but are not limited to: a portable computer diskette, a hard disk, a random access memory (“RAM”), a read-only memory (“ROM”), a Non-volatile RAM (NVRAM), an erasable programmable read-only memory (“EPROM” or Flash memory), an appropriate optical fiber with a repeater, a portable compact disc read-only memory (“CD-ROM”), an optical storage device, a magnetic storage device, or any suitable combination of the foregoing. Thus, a computer readable storage medium may be any tangible medium that can contain or store a program for use by or in connection with an instruction execution system, apparatus, or device. In some arrangements, the processor 132 and the memory 136 form various processing circuits or modules described with respect to the price monitoring system 104 (e.g., a mapping module 152 and a monitoring module 156).

Computer program code for carrying out operations utilizing a processor or CPU 132 for aspects of the present disclosure may be written in any combination of one or more programming languages, markup languages, style sheets and JavaScript libraries, including but not limited to Windows Presentation Foundation (WPF), HTML/CSS, Node, XAML, and JQuery, C, Basic, *Ada, Python, C++, C #, Pascal, *Arduino, JAVA and the likes. Additionally, operations can be carried out using any variety of compiler available.

The computer program instructions on memory 136 may be provided to the processor 132, where the processor 132 is of a general purpose computer, special purpose computer, microchip or any other programmable data processing apparatus to produce a machine, such that the instructions, which execute via the processor of the computer or other programmable instruction execution apparatus, create a mechanism for implementing the functions/acts specified in the flowchart and/or block diagram block or blocks. The computer instructions may do one or more of the following—map particular electronic labels of the plurality of electronic labels 108 to a particular product position 204, map a particular product 208 to a particular product position 204, compare information regarding an identity of a current product occupying a particular product position 204 to a product that is assigned to occupy the particular product position 204, and transmit display instructions for a particular product position 204 to the particular electronic label 108 deployed at that particular product position 204.

These computer program instructions may also be stored in the memory 136 (computer readable medium) that when executed can direct a computer, processor, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, processor, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

As shown, the price monitoring system 104 includes the communication module 140. The communication module 140 is structured for sending and receiving data from the electronic labels 108, the database server 112, computers, networks, cloud, and the like. In some embodiments, the communication module 140 may include Ethernet, USB connection, port connections of various types, wireless, combination thereof and the likes. In some embodiments, the communication module 140 includes any of a cellular transceiver (for cellular standards), local wireless network transceiver (for 802.11X, ZigBee, Bluetooth, Wi-Fi, or the like), wired network interface, a combination thereof (e.g., both a cellular transceiver and a Bluetooth transceiver), and/or the like. The communication module 140 may communicate in real-time, in intervals, on demand, or a combination thereof. The communication module 140 is configured to generate data packets that include product identity information and pricing information for a particular electronic label 108 at a particular product position 204.

The driving system 144 includes a motor (not shown), a battery (not shown), a navigation system (not shown), and a final drive system (not shown) configured to propel the price monitoring system 104 through the retail environment. The navigation system is configured to guide the price monitoring system 104 through the retail environment 200. The navigation system may be configured to guide the price monitoring system 104 along a predefined path through the retail environment during monitoring runs. The navigation system may be configured to guide the price monitoring system 104 to particular product positions 204, such as product positions 204 that have electronic labels 108 to be updated. The navigation system may include visual sensors, proximity sensors, and so forth to orient the price monitoring system 104 in the retail environment 200 and/or to avotid shoppers, employees, stocking equipment, and so forth. The final drive may include wheels, a conveyor belt, a propeller, and so forth.

The camera module 148 includes an image capture device such as a camera 160 and a camera driving system 164. The camera module 148 is mounted on the price monitoring system 104 so that the camera module 148 can capture image data of the products displayed at the particular product positions 204. The camera driving system 164 is configured to position (e.g., rotate, tilt up or down) the camera 160 so that the camera 160 can capture image data of a particular product position 204. The camera 160 does not capture data from machine-readable codes positioned in the product positions 204.

The mapping module 152 is configured to identify a particular electronic label 108 located at each particular product position 204 in the planogram and store identity information of the particular electronic label 108 at each particular product position 204 in the planogram to the mapping database. As described in greater detail below, identity information of the particular electronic label 108 may include a serial number, an IP address, etc. The mapping module 152 is configured to command the driving system 144 to position the price monitoring system 104 proximate a group of electronic labels 108 deployed in the retail environment 200. The mapping module 152 is close enough to communicate with electronic labels 108 over the network 128. The mapping module 152 is configured to receive the information indicative of the identities of each of the electronic labels 108. The mapping module 152 is configured to initiate communication with one of the electronic labels 108 and transmit instructions to output a particular pattern to that particular electronic label 108. The mapping module 152 is configured to identify the position of the particular electronic label 108 outputting the particular pattern and associate the identity information of that particular electronic label 108 to the position (e.g., the particular product position 204) in the mapping database 116. In some embodiments, the electronic labels 108 may include one or more LEDs, and the particular pattern may be a particular pattern of flashing the LEDs. In such embodiments, the price monitoring system 104 is configured to identify the position of the electronic label 108 outputting the particular flashing pattern using the camera module 148. In other embodiments, the particular pattern may be produced by modulating the strength of a Bluetooth or wireless signal produced by the electronic label 108. In such embodiments, the price monitoring system 104 is configured to identify the position of the electronic label 108 producing particular Bluetooth or wireless signal pattern using the communication module 140. In still other embodiments, the electronic labels 108 may include one or more audio output devices, and the particular pattern may be a particular sound pattern (e.g., in an audible or an inaudible frequency range). In such embodiments, the price monitoring system 104 is configured to identify the position of the electronic label 108 outputting the particular sound pattern using an audio input device. The mapping module 152 is configured to identify the product 208 located at the product position 204 corresponding to the electronic label 108 outputting the particular pattern. The mapping module is configured to associate the identity information of the particular product (e.g., the assigned product) to the position (e.g., the particular product position 204) in the mapping database 116. Thus, for each particular product position 204, the mapping database 116 includes identity information of the particular electronic label 108 at that particular product position 204 and information indicative of an assigned product to be at that particular product position 204. After the mapping module 152 has assigned all of the electronic labels 108 proximate the price monitoring system 104 to particular product positions 204, the mapping module 152 is configured to command the driving system 144 to position the price monitoring system 104 proximate another group of electronic labels 108 deployed in the retail environment 200. In such a manner, a human can simply deploy electronic labels 108 at each of the product positions, stock products at the particular locations and the price monitoring system 104 is able to assign specific identity information for each of the electronic labels 108 and each of the products to particular product positions 204 in the planogram without human intervention.

The monitoring module 156 is configured to command the price monitoring system 104 to move (e.g., drive or slide on a rail) around the retail environment 200 to verify that each of the electronic labels 108 in the retail environment displays information regarding the product currently positioned in the same product position 204 as the each of the electronic labels 108. The monitoring module 156 is configured to command the driving system 144 to command the price monitoring system 104 to travel through the retail environment. The monitoring module 156 is configured to command the camera module 148 to capture image data regarding the particular product 208 at a particular product position 204. The monitoring module 156 is configured to identify the product currently at the particular product position 204 based on the image data. The monitoring module 156 is configured to compare the identity of the product currently at the particular product position to the identity of the product assigned to at that particular product position (e.g., based on the mapping database 116).

In response to determining that the identity of the product currently at the particular product position 204 is likely the assigned product, the monitoring module 156 is configured to command the camera module 148 to capture image data regarding the particular product 208 at a next particular product position 204. In some embodiments, in response to determining that the identity of the product currently at the particular product 208 location is likely not the same as the assigned product, the monitoring module 156 is configured to send an error message indicating that an unassigned product is positioned at the particular product position 204. In such embodiments, the monitoring module 156 may be configured to transmit a notification to an employee indicating that an unassigned product is positioned at the particular product position 204.

In some embodiments, in response to determining that the identity of the product currently at the particular product 208 location is likely not the same as the assigned product, the monitoring module 156 is configured to query the pricing database 120 for the name and the price of the current product at the particular product position 204. The monitoring module 156 is configured to retrieve the identity information for the particular electronic label 108 from the mapping database 116, and transmit instructions to the electronic label 108 to display the name and pricing information for the product currently at the particular product position so as to update the electronic label 108 to match the product actually positioned at the particular product position 204.

In some embodiments, the monitoring module 156 may be configured to update the electronic label 108 to display the name and pricing information for the product currently at the product location the first time that the monitoring module 156 determines that the unassigned product is located at the particular product position 204. This update may occur in real-time or substantially real-time such that the electronic labels 108 may be updated on the fly. In some embodiments, the monitoring module 156 may not command the electronic label 108 to display the name and pricing information for the product currently at the product location until the product currently at the product position 204 has been at that product position 204 for a predefined period of time and/or a predetermined number of scheduled monitoring cycles. The monitoring module 156 is configured to transmit update instructions to the electronic labels 108 based on image data of the products at each particular position. Therefore, the price monitoring system 104 is configured to update pricing information without having to scan a machine-readable label associated with the product, the electronic label 108, and/or the product position 204.

In some embodiments, an operator of the system may desire to change a price of a particular product (e.g., due to a sale, due to a change in demand, a change in price from a supplier, etc.). The operator may transmit instructions for the change in price for the particular product to the price monitoring system 104 (e.g., via a computing device that can communicate with the price monitoring system 104 over the network 128, an operator input/output (I/O) interface on the price monitoring system 104, etc.). The monitoring module 156 is configured to receive the instructions to change the price of the particular product. In some embodiments, the instructions may include the position of the particular product.

In some embodiments, the monitoring module 156 may determine the position of the particular product from mapping database 116 or the pricing database 120. The monitoring module 156 is configured to command the driving system 144 to position the price monitoring system 104 proximate the electronic label 108 to be updated. When the monitoring module 156 is close enough to the electronic label 108 to be able to communicate with the electronic label 108 over the network 128, the monitoring module 156 is configured to retrieve the identity information for the particular electronic label 108 from the mapping database 116, and transmit instructions to the electronic label 108 to display the name and pricing information as specified in the operator instructions. The monitoring module 156 is configured to receive operator instructions to update a particular electronic label 108 to correspond to a planned product move in a similar manner.

Returning to FIG. 1, each electronic label 108 includes a display interface 168, a processor 172, a memory 176, a communication module 180, a display module 108, and an identity module 184. The display interface 168 is a display screen configured to display product information (e.g., the product name and pricing information) corresponding to the product 208 positioned at the particular product location 204 including the electronic label 108. In some embodiments, the electronic label 108 may include output communication devices such as a visual output device (e.g., one or more LEDs) and/or an audio output device. The display module 182 is configured to receive information regarding the product 208 positioned at the particular product position 204. Information regarding the product 208 may include a name of the product 208, a price of the product 208, a price per unit weight or volume of the product 208, and so forth. The display module 182 is configured to display the information regarding the product 208 on the display interface 168. The identity module 184 is configured to transmit identity information for the particular electronic label 108 to the price monitoring system 104. In some embodiments, the identity module 184 may be configured to transmit predefined identity information of the electronic label 108 to the price monitoring system 104. For example, the identity module 184 may transmit an IP address or a serial number to the price monitoring system 104.

The processor 172, the memory 176, and the communication module 180 may be substantially similar to the processor 132, the memory 136, and the communication module 140 described above with price monitoring system 104 and are not described in detail herein for the sake of brevity.

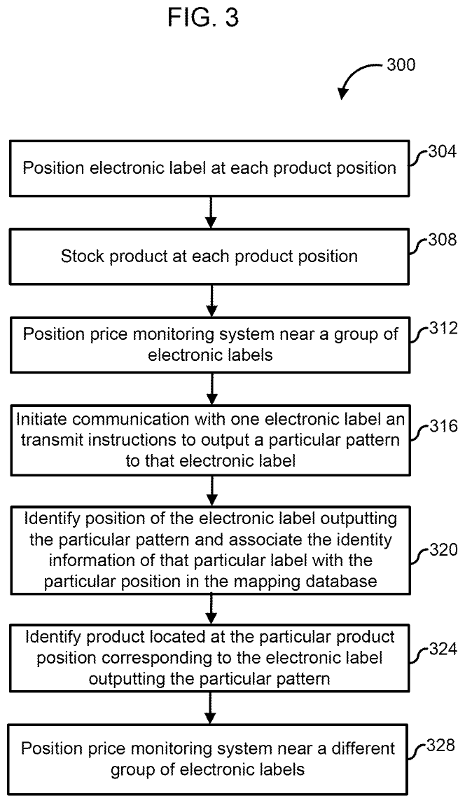

FIG. 3 is a schematic flow chart of a method 300 for calibrating a plurality of electronic labels 108 deployed in a retail environment 200. While the method 300 is described with respect to the price monitoring system 104 and the electronic labels 108, it should be appreciated that the operations of the method 300 may be implemented with any system that can communicate with electronic labels 108 and capture image of products 208 at product positions 204.

Processes 304 and 308 are preliminary steps in the calibration process 300 and may be done in any order. At process 304, a human positions an electronic label 108 at each product position 204 in a retail space. The human is not required to record information indicating which particular electronic labels 108 are positioned at particular positions in the retail space. At process 308, products 208 are stocked at the product positions 204. Stockers may not be required to record information indicating which particular electronic labels 108 are positioned at particular positions in the retail space.

At process 312, the mapping module 152 commands the driving system 144 to position the price monitoring system 104 proximate a group of electronic labels 108 deployed in the retail environment 200. The mapping module 152 is close enough to communicate with electronic labels 108 over the network 128 and can receive the information indicative of the identities of each of the electronic labels 108.

At process 316, the mapping module 152 initiates communication with one of the electronic labels 108 and transmits instructions to output a particular pattern to that particular electronic label 108. At process 320, the mapping module 152 identifies the position of the particular electronic label 108 outputting the particular pattern and associates the identity information of that particular electronic label 108 to the position (e.g., the particular product position 204) in the mapping database 116. For example, the electronic labels 108 may include one or more LEDs, and the particular pattern may be a particular pattern of flashing the LEDs. In such embodiments, the price monitoring system 104 identifies the position of the electronic label 108 outputting the particular flashing pattern using the camera module 148. In other embodiments, the particular pattern may be produced by modulating the strength of a Bluetooth or wireless signal produced by the electronic label 108. In such embodiments, the price monitoring system 104 identifies the position of the electronic label 108 producing the particular Bluetooth or wireless signal pattern using the communication module 140. In still other embodiments, the electronic label 108 may include one or more audio output devices, and the particular pattern may be a particular sound pattern. In such embodiments, the price monitoring system 104 identifies the position of the electronic label 108 outputting the particular sound pattern using an audio input device.

At process 324, the mapping module 152 identifies the product 208 located at the product position 204 corresponding to the electronic label 108 outputting the particular pattern. At process 328, the mapping module associates the identity information of the particular product 208 (e.g., the assigned product) to the position (e.g., the particular product position 204) in the mapping database 116. Thus, for each particular product position 204, the mapping database 116 includes identity information of the particular electronic label 108 at that particular product position 204 and information indicative of an assigned product 208 to be at that particular product position 204.

At process 328, after the mapping module 152 has assigned all of the electronic labels 108 located proximate to the price monitoring system 104 to particular product positions 204 in the mapping database and stored identity information of the particular product 208 at the particular product position 204 to the mapping database, the mapping module 152 is configured to command the driving system 144 to position the price monitoring system 104 proximate another group of electronic labels 108 deployed in the retail environment 200. In such a manner, a human can simply deploy electronic labels 108 at each of the product positions 204 and stock products 208 at the particular product positions 204, and the price monitoring system 104 is able to assign specific identity information for each of the electronic labels 108 as well as each of the products to particular product positions 204 in the planogram without human intervention.

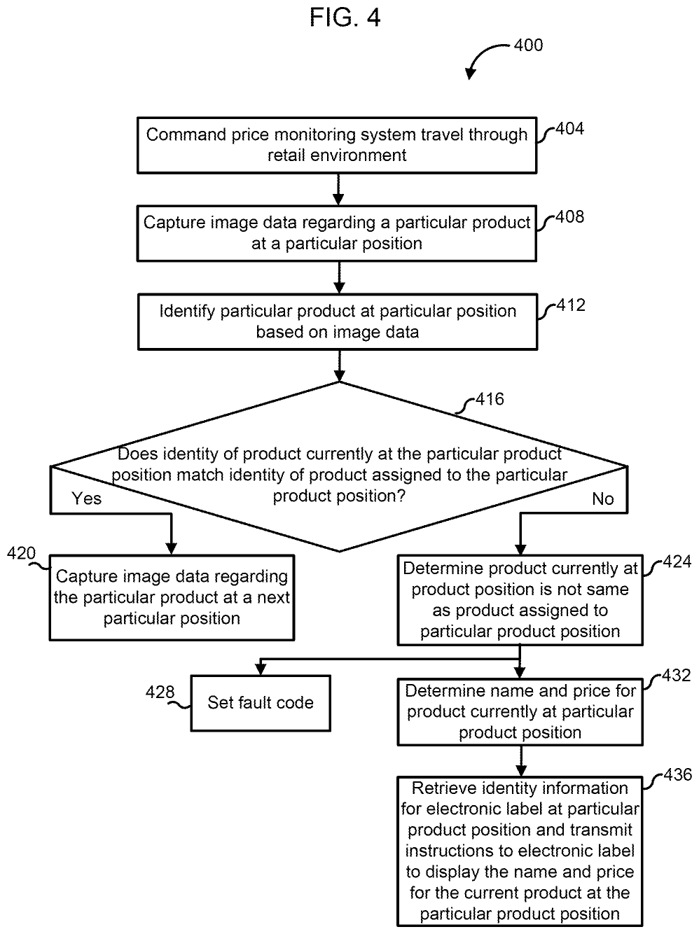

FIG. 4 is a schematic flow chart of a method 400 for monitoring a plurality of electronic labels 108 deployed in a retail environment 200. While the method 400 is described with respect to the price monitoring system 104 and the electronic labels 108, it should be appreciated the operations of the method 400 may be implemented with any system that can communicate with electronic labels 108 and capture image of the products 204 at product positions 208.

At process 404, the monitoring module 156 commands the driving system 144 to command the price monitoring system 104 to travel through the retail environment. At process 408, the monitoring module 156 is configured to command the camera module 148 to capture image data regarding the particular product 208 at a particular product position 204. At process 412, the monitoring module 156 identifies the product 208 currently at the particular product position 204 based on the image data.

At process 416, the monitoring module 156 compares the identity of the product currently at the particular product position 204 to the identity of the product 208 assigned to that particular product position 204 (e.g., based on the mapping database 116 or the pricing database 120). At process 420, in response to determining that the identity of the product 208 currently at the particular product position 204 is likely the assigned product 208, the monitoring module 156 commands the camera module 148 to capture image data regarding the particular product 208 at a next particular product position 204.

At process 424, the monitoring module determines that the product 208 currently at the particular product position 204 is likely not the same as the assigned product. At process 428, in some embodiments, in response to determining that the identity of the product 208 currently at the particular product position 204 is likely not the same as the assigned product, the monitoring module 156 sets a fault code indicating that an unassigned product is positioned at the particular product position 204 to an employee of the retail environment. In such embodiments, the monitoring module 156 may transmit a notification to an employee indicating that an unassigned product is positioned at the particular product position 204.

At process 432, in some embodiments, in response to determining that the product 208 currently at the particular product position 204 is likely not the same as the assigned product, the monitoring module 156 determines the name and the price of the current product at the particular product position 204. For example, the monitoring module 156 may query the pricing database 120 for the name and the price of the current product at the particular product position 204. At process 436, the monitoring module 156 retrieves the identity information for the particular electronic label 108 from the mapping database 116, and transmits instructions to the electronic label 108 to display the name and pricing information for the product 208 currently at the particular product position 204 to update the electronic label 108 to match the product 208 actually positioned at the particular product position 204.

In some embodiments, the monitoring module 156 may update the electronic label 108 to display the name and pricing information for the product 208 currently at the particular product position 204 the first time that the monitoring module 156 determines that the product 208 at the particular product position 204 is different than the product assigned to that particular product position 204. This update may occur in real-time or substantially real-time such that the electronic labels 108 may be updated on the fly. In some embodiments, the monitoring module 156 may not command the electronic label 108 to display the name and pricing information for the product 208 currently at the product position 204 until the product 208 currently at the product position 204 has been at that product position 204 for a predefined period of time and/or a predetermined number of scheduled monitoring cycles. The monitoring module 156 transmits update instructions to the electronic labels 108 based on image data of the products 208 at each particular position 204. Therefore, the price monitoring system 104 is configured to update product information displayed by the electronic label 108 without having to scan a machine-readable label associated with the product 208, the electronic label 108, and/or the particular product position 204.

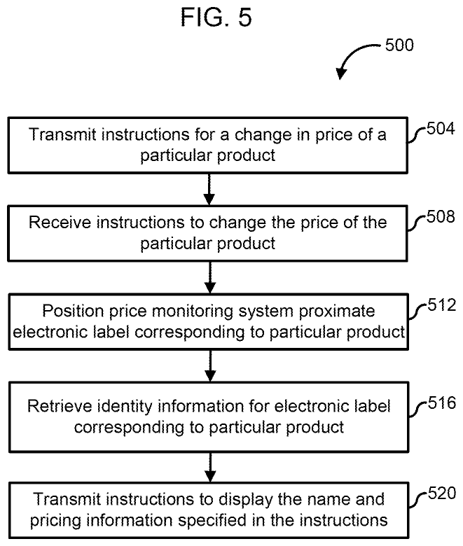

FIG. 5 is a schematic flow chart of a method 500 for changing the information displayed by an electronic label 108 at a particular product position 204. While the method 500 is described with respect to the price monitoring system 104 and the electronic labels 108, it should be appreciated the operations of the method 500 may be implemented with any system that can communicate with electronic labels 108 and capture images of products 208 at product locations 204.

An operator of the system may desire to change a price of a particular product 208 (e.g., due to a sale, due to a change in demand, a change in price from a supplier, etc.). At process 504, the operator transmits instructions for the change in price for the particular product to the price monitoring system 104 (e.g., via a computing device that can communicate with the price monitoring system 104 over the network 128, an operator input/output (I/O) interface on the price monitoring system 104, etc.). At process 508, the monitoring module 156 receives the instructions to change the price of the particular product 204. In some embodiments, the instructions may include the position of the particular product 204. In some embodiments, the monitoring module 156 may determine the position of the particular product 204 from the mapping database 116 or the pricing database 120. At process 512, the monitoring module 156 commands the driving system 144 to position the price monitoring system 104 proximate to the electronic label 108 to be updated. At process 516, when the monitoring module 156 is close enough to the electronic label 108 to be able to communicate with the with electronic label 108 over the network 128, the monitoring module 156 retrieves the identity information for the particular electronic label 108 from the mapping database 116. At process 520, the monitoring module 156 transmits instructions to the electronic label 108 to display the name and pricing information as specified in the operator instructions. The monitoring module 156 can receive operator instructions to update a particular electronic label 108 to correspond for a planned product move in a similar manner. Therefore, the price monitoring system 104 is configured to change product information displayed on the electronic label 108 without having to scan a machine-readable label associated with the product 208, the electronic label 108, and/or the product position 204.

It should be noted that the term “example” as used herein to describe various embodiments or arrangements is intended to indicate that such embodiments or arrangements are possible examples, representations, and/or illustrations of possible embodiments or arrangements (and such term is not intended to connote that such embodiments or arrangements are necessarily crucial, extraordinary, or superlative examples). The arrangements described herein have been described with reference to drawings. The drawings illustrate certain details of specific arrangements that implement the systems, methods and programs described herein. However, describing the arrangements with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “module” may include hardware structured to execute the functions described herein. In some arrangements, each respective “module” may include machine-readable media for configuring the hardware to execute the functions described herein. The module may be embodied as one or more circuitry components including, but not limited to, processing circuitry, network interfaces, peripheral devices, input devices, output devices, sensors, etc. In some arrangements, a module may take the form of one or more analog circuits, electronic circuits (e.g., integrated circuits (IC), discrete circuits, system on a chip (SOCs) circuits, etc.), telecommunication circuits, hybrid circuits, and any other type of “module.” In this regard, the “module” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “module” may also include one or more processors communicatively coupled to one or more memory or memory devices. In this regard, the one or more processors may execute instructions stored in the memory or may execute instructions otherwise accessible to the one or more processors. In some arrangements, the one or more processors may be embodied in various ways. The one or more processors may be constructed in a manner sufficient to perform at least the operations described herein. In some arrangements, the one or more processors may be shared by multiple circuits (e.g., circuit A and circuit B may comprise or otherwise share the same processor which, in some example arrangements, may execute instructions stored, or otherwise accessed, via different areas of memory). Alternatively or additionally, the one or more processors may be structured to perform or otherwise execute certain operations independent of one or more co-processors. In other example arrangements, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some arrangements, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “module” as described herein may include components that are distributed across one or more locations.

An exemplary system for implementing the overall system or portions of the arrangements and embodiments might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some arrangements, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other arrangements, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example arrangements described herein.

It should also be noted that the term “input devices,” as described herein, may include any type of input device including, but not limited to, a keyboard, a keypad, a mouse, joystick, touch sensitive screen or other input devices performing a similar function. Comparatively, the term “output device,” as described herein, may include any type of output device including, but not limited to, a computer monitor, printer, facsimile machine, a LAN card or WiFi® transmission circuit for data transmission or other output devices performing a similar function

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative arrangements. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and

While this specification contains many specific implementation details, these should not be construed as limitations on the scope of any arrangement or of what may be claimed, but rather as descriptions of features specific to particular implementations of particular arrangements. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A price monitoring system, comprising:
a memory; and
a processor configured to:
determine an identity of a product positioned a particular location based on image information regarding the product;
compare, the identity of the determined product positioned at the particular location to an identity of an assigned product assigned to that particular location;
determine, based on the comparison, that the identity of the product positioned at the particular location does not match the identity of the assigned product assigned to that particular location;
retrieve product information for the product positioned at the particular location from a product database; and
transmit instructions configured to command an electronic product label at the particular location to display the product information for the product positioned at the particular location.

2. The price monitoring system of claim 1, wherein the processor is configured to replace the identity of the assigned product assigned to that particular location with the identity of the determined product positioned at the particular location within the product database.

3. The price monitoring system of claim 1, wherein the processor is further configured to transmit a message to a user device when the identity of the determined product positioned at the particular location does not match the identity of the assigned product assigned to that particular location indicating a misplaced item.

4. The price monitoring system of claim 1, wherein the processor is configured to identify the electronic product label at the particular location based on a digital planogram of a retail space including the particular location.

5. The price monitoring system of claim 1, wherein:
the price monitoring system includes an image capture device configured to capture an image of the product; and
the image information is determined from the captured image of the product.

6. The price monitoring system of claim 5, wherein the image information is not determined based on a machine readable code displayed on the product.

7. The price monitoring system of claim 1, wherein the product information comprises at least one of a product price, a product identification number, or a product description.

8. A method comprising:
determining, by a price monitoring system, an identity of a determined product positioned a particular location based on image information regarding the determined product;
comparing, by the price monitoring system, the identity of the determined product positioned at the particular location to an identity of an assigned product assigned to that particular location;
determining, based on the comparison by the price monitoring system, that the identity of the determined product positioned at the particular location does not match the identity of the assigned product assigned to that particular location; and
transmitting, by the price monitoring system, instructions configured to command an electronic product label at the particular location to display the product information for the determined product positioned at the particular location.

9. The method of claim 8, wherein the method further comprises replacing, by the price monitoring system, the identity of the assigned product assigned to that particular location with the identity of the determined product positioned at the particular location.

10. The method of claim 8, wherein the method further comprises transmitting, by the price monitoring system, a message to user device when the identity of the determined product positioned at the particular location does not match the identity of the assigned product assigned to that particular location indicating a misplaced item.

11. The method of claim 8, wherein the method further comprises identifying, by the price monitoring system, the electronic product label at the particular location based on a digital planogram of a retail space including the particular location.

12. The method of claim 8, wherein:
the price monitoring system includes an image capture device configured to capture an image of the determined product, and
the image information is determined from the captured image of the determined product.

13. The price monitoring system of claim 12, wherein the image information is not determined based on a machine readable code displayed on the determined product.

14. An apparatus comprising:
a camera driving system; and
a price monitoring system comprising:
a memory; and
a processor configured to:
determine an identity of a determined product positioned a particular location based on image information regarding the determined product,
compare, by the price monitoring system, the identity of the determined product positioned at the particular location to an identity of an assigned product assigned to that particular location,
determine, based on the comparison, that the identity of the determined product positioned at the particular location does not match the identity of the assigned product assigned to that particular location, and
transmit instructions configured to command an electronic product label at the particular location to display the product information for the determined product positioned at the particular location.

15. The apparatus of claim 14, wherein the processor is configured to replace the identity of the assigned product assigned to that particular location with the identity of the determined product positioned at the particular location.

16. The apparatus of claim 14, wherein the processor is further configured to transmit a message to user device when the identity of the determined product positioned at the particular location does not match the identity of the assigned product assigned to that particular location indicating a misplaced item.

17. The apparatus of claim 14, wherein the processor is configured to identify the electronic product label at the particular location based on a digital planogram of a retail space including the particular location.

18. The apparatus of claim 14, wherein:
the camera driving system includes an image capture device coupled to a final drive system configured to capture an image of the determined product; and
the image information is determined from the captured image of the determined product.

19. The apparatus of claim 18, wherein the image information is not determined based on a machine readable code displayed on the determined product.

20. The apparatus of claim 14, wherein the product information comprises at least one a product price, a product identification number, oe a product description.
